(19) United States
(12) Patent Application Publication
(10) Pub. No.: US 2008/0240835 A1
(43) Pub. Date: Oct. 2, 2008

(54) Input Tray Cover For An Image Forming Device

(76) Inventors: Edward Lynn Triplett, Lexington, KY (US); Joseph Edwin Domhoff, Shelbyville, KY (US); Brian Allen Blair, Richmond, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/693,296

(22) Filed: Mar. 29, 2007

(51) Int. Cl. B41J 29/02

(52) U.S. Cl. 400/691

(57) ABSTRACT

The present application is directed to devices and methods of protecting an input tray of an image forming apparatus. One embodiment of a device may include a mounting bracket that is attached to and positioned within an interior of the image forming apparatus. A cover may be movably attached to the mounting bracket. The cover may be positionable between a first retracted orientation positioned within the interior of the image forming apparatus and a second extended orientation positioned over a portion of the input tray that extends outward from the interior of the image forming apparatus. A biasing member may be operatively connected to the cover to bias the cover towards the first retracted orientation.

### BACKGROUND

The present application is directed to an input area for image forming devices and, more specifically, to a protective device positionable over a section of an input tray that extends outward from an interior of the image forming device.

Image forming devices, such as color laser printers, produce images on print media that pass along a media path. One drawback to these conventional devices is their relatively large size. Particularly, these devices typically include additional components necessary for aligning media along the media path, duplex printing, and cooling, for example. While these components may provide high-quality images, they necessarily increase the overall size of the device. The overall size is an important aspect for consumers when purchasing a device. Workspace, such as a desktop, is often limited and is not able to accommodate large devices. Further, large devices are more difficult to physically lift and move around a workspace. Smaller devices are more convenient for moving and positioning in new locations.

Another important aspect is their ease of use. Media input and output areas, for example, should be easily accessible to a user. The locations of these areas should allow a user to load and unload the print media without moving the device. The user should also be able to remove media that becomes jammed in the media path without having to move the device from its position.

Consumers also consider the overall cost of the device during a purchasing decision. Therefore, the architecture of the device should not greatly affect the cost of the device. An architecture that increases the overall cost may be a detriment to a consumer.

### SUMMARY

The present application is directed to devices and methods of protecting an input tray of an image forming apparatus. One embodiment of a device may include a mounting bracket that is attached to and positioned within an interior of the image forming apparatus. A cover may be movably attached to the mounting bracket. The cover may be positionable between a first retracted orientation positioned within the interior of the image forming apparatus and a second extended orientation positioned over a portion of the input tray that extends outward from the interior of the image forming apparatus. A biasing member may be operatively connected to the cover to bias the cover towards the first retracted orientation.

One method of protecting the input tray may include initially positioning the cover within an interior of the image forming apparatus. The input tray may be inserted into the image forming apparatus. During insertion, a leading end of the input tray may contact the cover. Further insertion of the input tray causes the cover to move from the initial first orientation, towards a second extended orientation. A depth of the input tray may be greater than the image forming apparatus resulting in a first, leading section of the input tray extending outward from a second side of the image forming apparatus. The cover remains in contact with the input tray during insertion and is moved to the second extended orientation. The second orientation extends outward from the image forming apparatus and may be positioned over the section of the input tray that extends outward from the second side.

### BRIEF DESCRIPTION OF THE DRAWINGS

FIG. 1 is a perspective view of a protective device positioned over an input tray according to one embodiment.

FIG. 2 is a side schematic view of an image forming device according to one embodiment.

FIG. 3 is a perspective view of an input tray according to one embodiment.

FIG. 4 is a perspective view of an input tray according to one embodiment.

FIG. 5A is a side view of a back wall of an input tray receptacle in a first orientation according to one embodiment.

FIG. 5B is a perspective view of the back wall of the receptacle in the first orientation according to one embodiment.

FIG. 6A is a side view of a back wall of an input tray receptacle in a second orientation according to one embodiment.

FIG. 6B is a perspective view of the back wall of the receptacle in the second orientation according to one embodiment.

FIG. 7A is a side view of a back wall of an input tray receptacle in a second orientation according to one embodiment.

FIG. 7B is a perspective view of the back wall of the receptacle in the second orientation according to one embodiment.

FIG. 8 is a perspective view of an input tray according to one embodiment.

FIG. 9 is a perspective view of an input tray according to one embodiment.

### DETAILED DESCRIPTION

The present application is directed to a protective device that includes a cover that extends over a section of an input tray. The protective device is expandable depending upon the size of the media sheets within the input tray. The device is in a first, recessed orientation when the media sheets are small, or the input tray is removed from the body of the image forming device. The device is extended to a second orientation when relatively long media sheets are within the input tray.

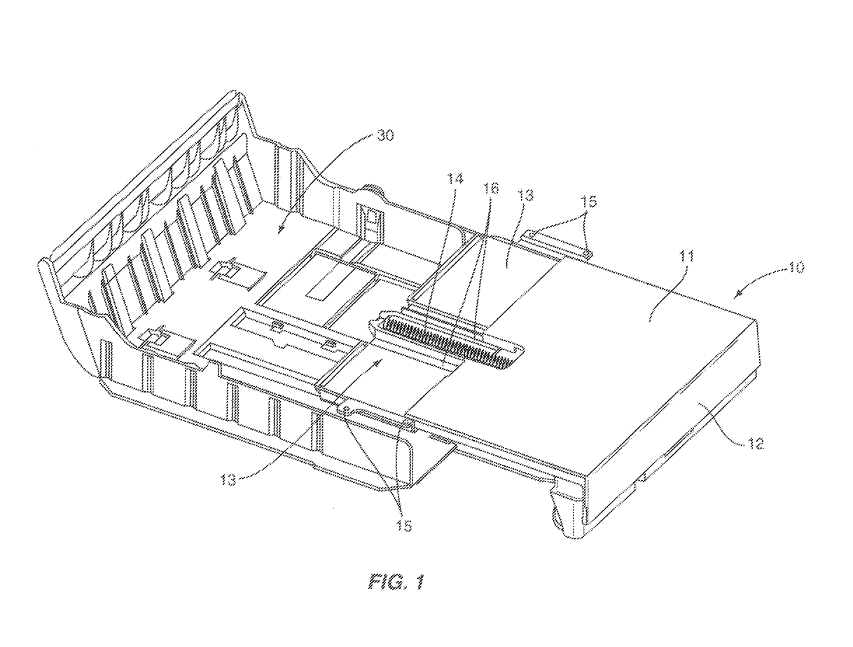

FIG. 1 illustrates one embodiment of the protective device 10 that includes a cover 11 that may also include a side section 12. One or more mounting brackets 13 are positioned to attach the tray 10 to the body of the image forming device. The cover 11 is movable between a first, recessed orientation and a second, extended orientation. A biasing member 14 biases the cover 11 towards the recessed orientation. In one embodiment, the device 10 is attached to the body of the image forming device. The cover 11 is then positionable at various positions between the first and second orientations based on the size of the media sheets within the input tray 30.

In one embodiment, the protective device 10 is positioned protect a section of the media sheets that extend outward from the image forming device. As illustrated in FIG. 1, the cover 11 includes a top section sized to extend over a portion of the input tray 30. Cover 11 may also include a side section 12 that extends outward from the top section. The side section 12 may extend across the entire width of the top section, or along a limited width. The widths of the top and side sections 12 may be substantially equal or different. In one embodiment, the width of each of the sections is about equal to a width of the input tray 30. In another embodiment, the width of one or both sections 11, 12 is less than the input tray 30.

The protective device 30 also includes one or more mounts 13 that attach to the image forming device. In one embodiment as illustrated in FIG. 1, mounts 13 are positioned along each side of the cover 11. The mounts 13 may include apertures 15 sized to receive fasteners for attaching the cover to the image forming device. Mounts 13 may further include rails 16 to receive the top section 11. The rails 16 provide for the cover 11 to be movable relative to the mounts 13 to extend over the top of the input tray 30. A biasing mechanism 14 extends between the mount 13 and cover 11 to bias the cover 10 towards the closed, first orientation. In one embodiment, biasing mechanism 14 includes a first end attached to a mount 13 and a second end attached to the cover 11.

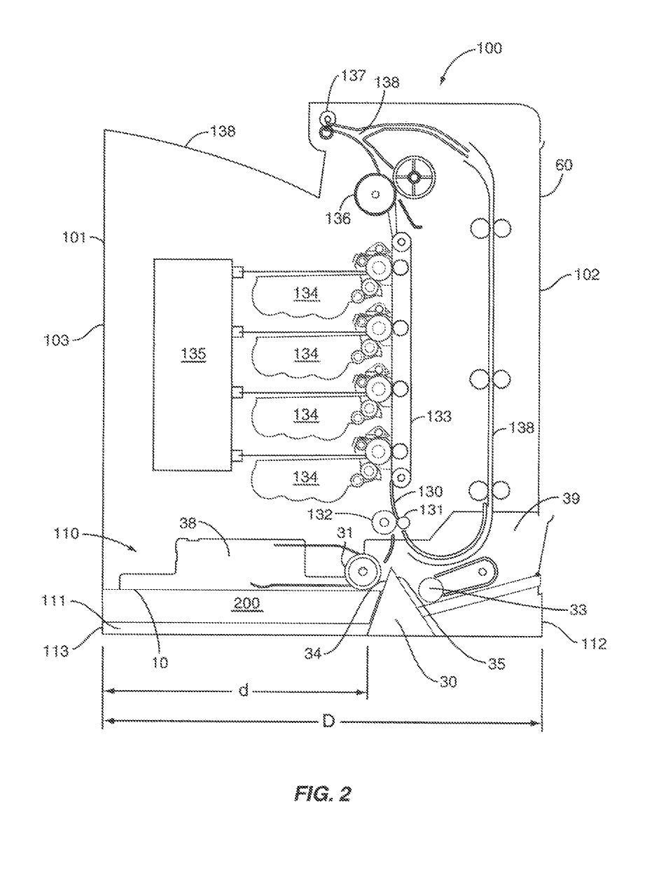

FIG. 2 illustrates a representative image forming device 100, such as a printer, according to one embodiment. The exemplary image forming device 100 comprises a main body 101 with a first side 102 and a second side 103. In one embodiment, the first side 102 is a front of the image forming device 100 and may include an input mechanism and display screen for controlling the image formation process. An input area 110 is positioned towards a bottom of the main body 101. The input area 110 includes a cavity 111 sized to receive the input tray 30. The cavity 111 includes a first opening 112 on the first side 102 of the body 101, and a second opening 113 on the second side 103. The cavity 111 provides for the input tray 30 to be removable from the main body 101. In one embodiment, the input tray 30 inserted and removed from the main body 101 through the first opening 112. The device 10 is positioned in the cavity 111. In one embodiment, the device 10 is in proximity to the second opening 112 at the second side 103 and may be positioned within the cavity 111 when the input tray 30 is removed. The depth of the main body 101 is reduced such that the input tray 30 may extend outward beyond the second side 103 depending upon the size of the media sheets 200 within the input tray 30. The device 10 extends over the section of the input tray 30 that extends outward from the second side 103 as will be explained below.

The input tray 30 is sized to fit within the cavity 111 to store media sheets that are introduced into the main body 101 during the image formation process. The input tray 30 includes a first area 38 sized to hold a stack of media sheets 200. A pick mechanism 31 may be positioned at the input area 38 to introduce the media sheets 200 from the stack into a media path 130 responsive to the receipt of a pick command. The input tray 30 may also include a second, input area 39 to introduce media sheets into the media path 130. Second input area 39 includes an associated pick mechanism 33 to feed media sheets introduced by a user from outside the body 101 of image forming device 100.

From the first and second input areas 38, 39, media sheets are deflected by guides 34, 35 towards the main media path 130. One or more registration rollers 131, 132 disposed along the media path 130 aligns the media sheet and precisely controls its further movement. A media transport belt 133 forms a section of the media path 130 for moving the media sheets past a plurality of image forming units 134. In a typical color electrophotographic printer such as exemplary device 100, three or four colors of toner—cyan, yellow, magenta, and optionally black—are applied successively to the media sheet to create a color image. Correspondingly, the embodiment of FIG. 2 depicts four image formation units 134 arrayed along the media transport belt 133. The transport belt 133 carries the media sheet successively past the image formation units 134. At each unit 134, optical device 135 forms a latent image onto an associated photoconductive member or PC drum (not specifically labeled). The latent image is then developed by applying toner to the PC drum. The toner is subsequently deposited on the media sheet as it is conveyed past the image formation unit 134.

Once the media sheet moves past the image forming units 134, a fuser 136 thermally fuses the loose toner to the media sheet. The sheet then passes through reversible exit rollers 137 to the output area 138 formed on the exterior of image forming device 100. Alternatively, the exit rollers 137 may reverse direction after the trailing edge of the media sheet has passed the entrance to a duplex path 138, thus directing the media sheet through the duplex path 138 and again into the main media path 130 to print a duplex image on the opposite side of the media sheet. It should be understood that while the foregoing description relates to a color electrophotographic printer as shown in FIG. 2, the present application is not limited to color printers, but may be advantageously applied to other types of image forming devices 100, including but not limited to, single-color laser printers and inkjet printers.

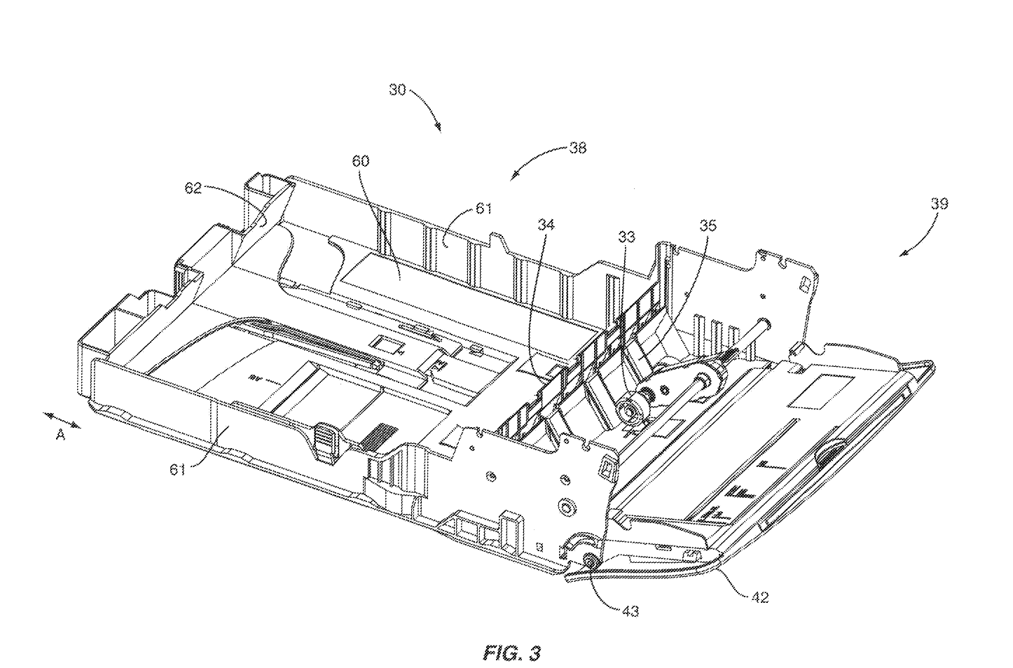

As FIG. 3 illustrates, the input tray 30 combines first and second input areas 38, 39 into a common assembly, thus conserving vertical space in the image forming device 100. The first input area 38 includes a receptacle 60 to contain a stack of the media sheets 200. In one embodiment, the second input area 39 includes a door 42 that is movable about pivots 43. The door 42 may be in a closed orientation as illustrated in FIG. 2 when no media sheets 200 are being inserted, and in an open orientation as illustrated in FIG. 3. In the open orientation, the door 42 provides a support platform to position the media sheets 200 being inserted through the second input area 39. One example of an input tray is disclosed in U.S. patent application Ser. No. 11/211,818 filed on Aug. 25, 2005, herein incorporated by reference in its entirety.

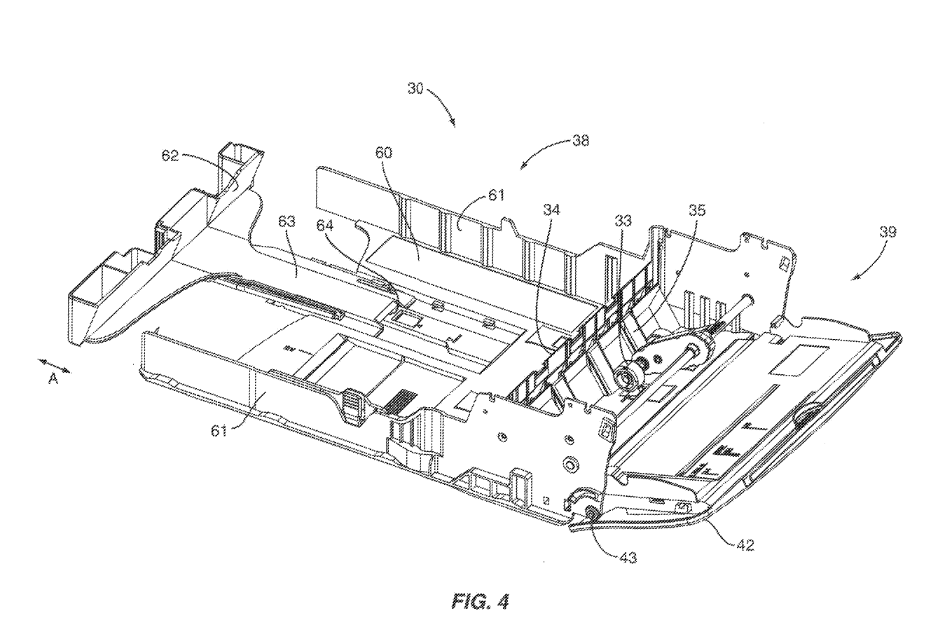

As illustrated in FIG. 3, the receptacle 60 is formed between side walls 61, the media guide 34, and a back wall 62. In one embodiment, the back wall 62 is adjustable to accommodate media sheets 200 of various sizes. As illustrated in FIG. 3, the back wall 62 is in a first, reduced orientation in contact with the side walls 61. As illustrated in FIG. 4, a tab 63 may extend outward from the back wall 62 and fit within a slot 64 in the bottom of the receptacle 60. The tab 63 and slot 64 arrangement may provide for selectively positioning the back wall 62 in the directions indicated by arrow A to adjust a depth d of the receptacle 60 to accommodate various sizes of media sheets 200. In one embodiment, the user removes the input tray 30 from the main body 101 of the image forming device 100. Once remove, the back wall 62 can be adjusted accordingly and media sheets inserted into the receptacle 60. Once the sheets 200 are loaded, the input tray 30 may be reinserted into the main body 101.

As illustrated in FIG. 2, the depth D of the device 100 extends between the first and second sides 102, 103. In an effort to accommodate users and make the overall size of the device 100 as small as possible, the depth D is reduced. This results in media sheets that exceed a certain length extending outward beyond the second side 103 of the main body 101. The protective device 10 extends over the section that extends outward from the second side 103 to protect the media sheets 200.

The protective device 10 is attached to the main body 101 at a point adjacent to the cavity 111. In one embodiment, the one or more mounts 13 on the device 10 are attached to an upper wall of the cavity 111. This also places the cover 11 at a point where it is contacted by the input tray 30 during insertion of the input tray 30 into the cavity 111. In one embodiment, the cover 11 is positioned within the interior of the body 101 prior to insertion of the input tray 30. In one embodiment, the side 12 is substantially aligned with the second side 103 of the main body 101 prior to insertion of the input tray 30. In another embodiment, the side 12 is positioned inward from the second side 103 prior to insertion of the input tray 30.

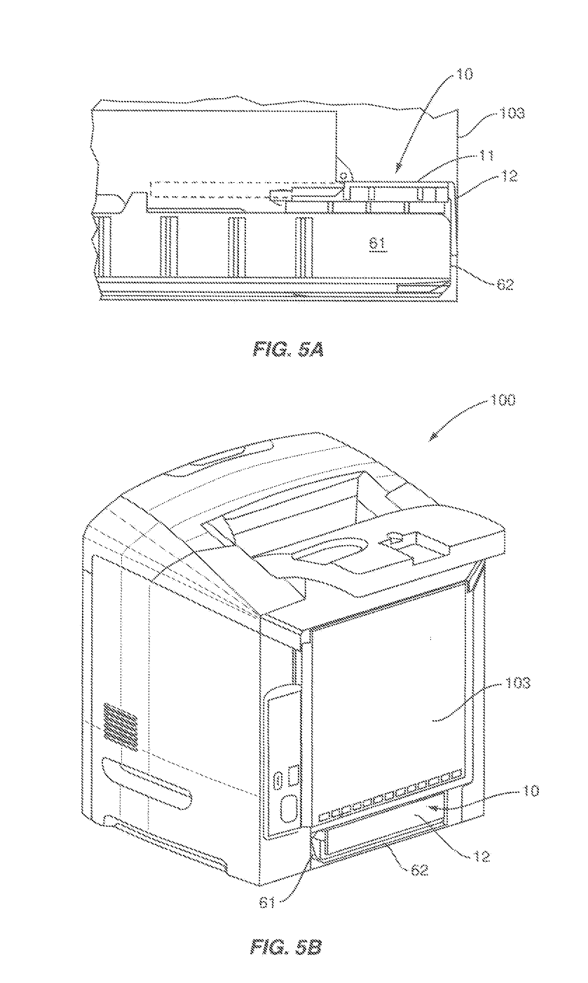

FIGS. 5A and 5B illustrate the protective member 10 in one orientation when the media sheets 200 are relatively short such that they do not extend outward beyond the second side 103. One example of relatively short media sheets 200 includes A5 media sheets. In one embodiment, a leading edge of the input tray 30 is sized to substantially align with the second side 103 when the input tray 30 is inserted within the cavity 111. This orientation causes the side 12 to be substantially aligned with the second side 103 after insertion of the input tray 30.

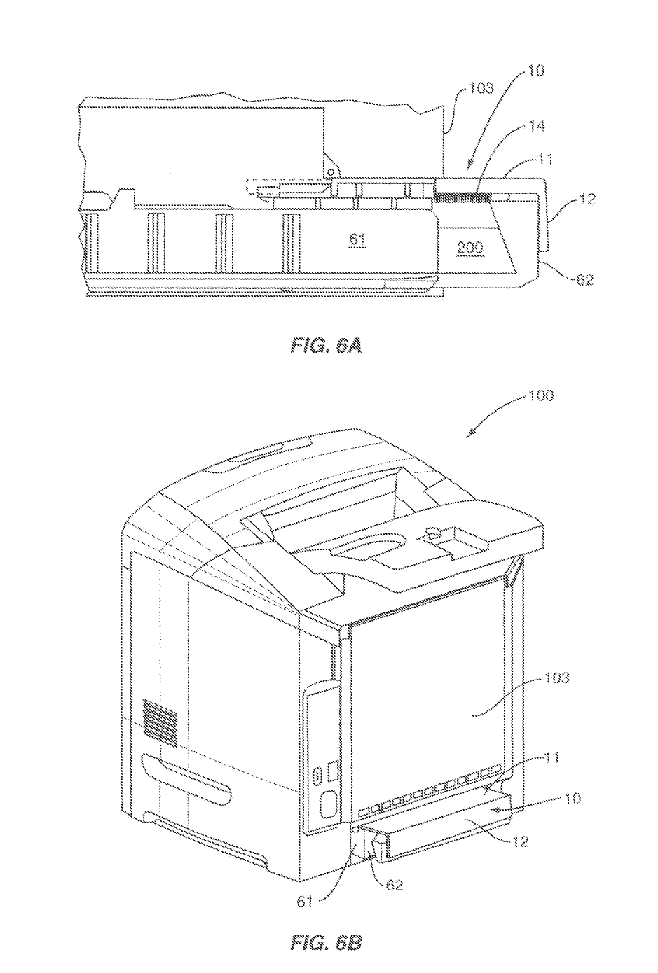

FIGS. 6A and 6B illustrate the protective device 10 in a second orientation. The media sheets 200 in this embodiment include a length that extends outward from the second side 103. One embodiment may include letter-sized media sheets. During insertion of the input tray 30 into the cavity 111, the leading edge of the input tray 30 contacts the cover 11. The insertion force of the input tray 30 causes the cover 11 to move relative to the mounting bracket 13 and extend outward from the second side 103. In one embodiment, the side 12 of the cover 11 contacts against the leading edge of the input tray 30. The cover 11 extends over a top of the input tray that extends outward from the second side 103 and protects against damage to the media sheets 200.

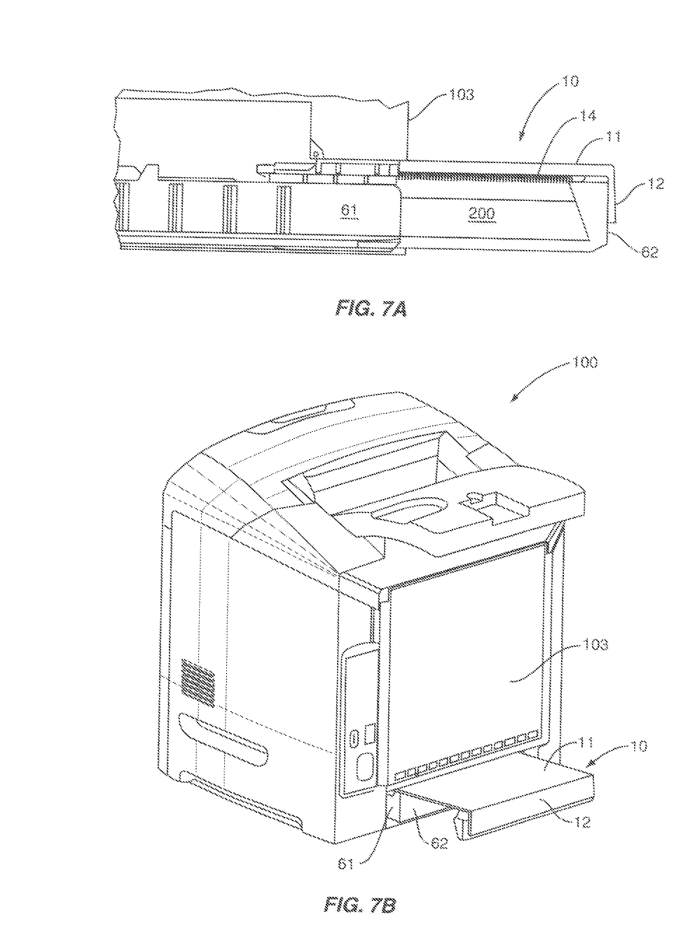

FIGS. 7A and 7B illustrate another orientation to accommodate even longer media sheets 200, such as legal-sized sheets. The cover 11 is moved even further outward from the second side 103 to extend over that extended portion of the media sheets.

FIGS. 5A-7B illustrate three orientations of the protective device 10. It is understood that the protective device 10 may be positioned at a variety of orientations to accommodate the various lengths of media sheets 200. In one embodiment with the side 12 contacting the back wall 62, the device 10 is positioned at the various orientations independent of whether there is actually media within the receptacle 22.

In one embodiment, the top section of the cover 11 is substantially flat and slides across the substantially flat mount 13. The flat surfaces of the top section and mount 13 accommodate the sliding motion and do not require an excessive amount of force to move the cover 11 to the various extended positions. Further, the flat surfaces facilitate returning the cover to the home, starting position by the biasing member 14 when the input tray 30 is removed form the image forming device 100.

In one embodiment, the protective device 10 is connected to an upper side of the cavity 111. This positioning provides for the cover 11 to be contacted during insertion of the input tray 30. In one embodiment, the side 12 extends across a large section of the cavity to ensure contact with the leading edge of the input tray 30.

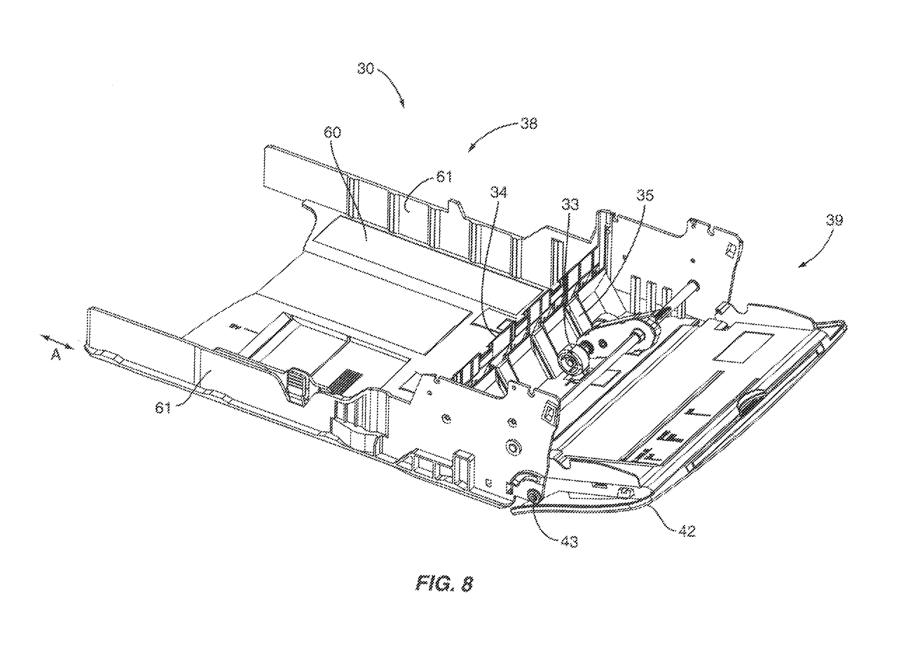

In one embodiment as illustrated in FIG. 8, the input tray 30 does not include a back wall 62. The back area is substantially open. Relatively long media sheets 200 that exceed the length of the receptacle 60 extend outward through the open side. In this embodiment, the cover 11 is contacted by either the media sheet 200 or another section of the input tray 30 to move outward and extend over the portion of the sheets 200 outward from the second side 103.

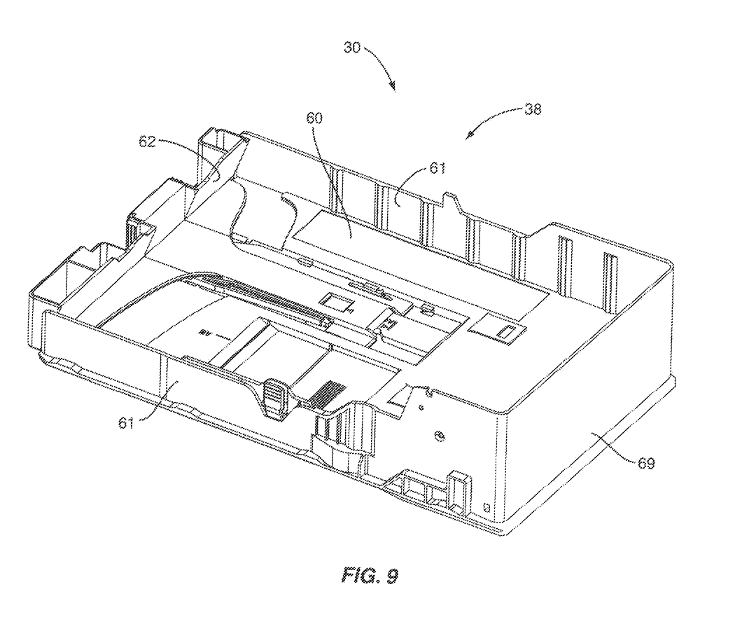

FIGS. 3 and 4 illustrate one embodiment of an input tray 30 for use with the image forming device 100. FIG. 9 illustrates another embodiment that includes a receptacle 60 sized to contain a stack of media sheets 200. The input tray includes a front wall 69 and a back wall 62. The input tray 30 does not include any additional input areas.

In the embodiment illustrated, the image-forming device 100 is a color laster printer. In another embodiment, image-forming device 100 is a mono printer comprising a single imaging unit 134 for forming toner images in a single color. In another embodiment, the image-forming device 100 includes a secondary transfer system with the toner images initially transferred to an intermediate member and then transferred a second time to the media sheets.

In one embodiment, the protective device 10 is attached to the body 101 of the image forming device 100. In this embodiment, the device 10 remains attached to the body 101 when the input tray 30 is removed. In another embodiment, the device 10 may be attached to the input tray 30.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

The present application may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A device to protect an input tray of an image forming apparatus comprising:
a mount attached to and positioned within an interior of the image forming apparatus;
a cover movably attached to the mount and positionable between a first retracted orientation positioned within the interior of the image forming apparatus and a second extended orientation positioned over a portion of the input tray that extends outward from the interior of the image forming apparatus; and
a biasing member operatively connected to the cover to bias the cover towards the first retracted orientation.

2. The device of claim 1, wherein the cover is substantially L-shaped with a top section that extends over the top of the input tray and a side section that extends downward from the top section.

3. The device of claim 1, wherein the mount includes rails that engage with the cover during movement of the cover between the first retracted orientation and the second extended orientation.

4. The device of claim 1, wherein a section of the cover that extends over the portion of the input tray is substantially flat.

5. The device of claim 1, wherein a section of the cover that extends over the portion of the input tray includes a width that is less than the input tray.

6. The device of claim 1, wherein the biasing member includes a first end attached to the cover and a second end attached to the mount.

7. The device of claim 1, wherein an outer edge of the cover is positioned within the interior of the image forming apparatus when the cover is in the first orientation and positioned on an exterior of the image forming apparatus when the cover is in the second orientation.

8. A device to protect an input tray of an image forming apparatus comprising:
a cover movably attached to the image forming apparatus and movable between a first orientation with a first edge positioned within the image forming apparatus and a second orientation with the first edge extending outward from the image forming apparatus and over a portion of the input tray that extends outward from the image forming apparatus; and
a biasing member to bias the cover towards the first orientation.

9. The device of claim 8, further comprising a mount fixedly attached to the image forming apparatus, the mount operatively connected to the cover and adapted to allow the cover to move between the first and second orientations.

10. The device of claim 9, wherein the mount is sized to fit completely within an interior of the image forming apparatus.

11. The device of claim 9, further comprising a second mount fixedly attached to the image forming apparatus, the second mount operatively connected to the cover and adapted to allow the cover to move between the first and second orientations.

12. The device of claim 9, wherein the cover includes a first section that extends over the portion of the input tray that extends outward from the image forming apparatus when the cover is in the second orientation, the cover further includes a second section that extends outward from the first section and contacts a side of the input tray when the cover is in the second orientation.

13. The device of claim 12, wherein a width of the first section is less than the input tray.

14. A method of protecting an input tray of an image forming apparatus comprising:
positioning a protective device in an initial orientation within an interior of the image forming apparatus;
inserting the input tray into a first side of the image forming apparatus and into the interior of the image forming apparatus;
while moving the input tray into the interior of the image forming apparatus, contacting the input tray against a cover of the protective device; and
moving the cover from the initial orientation within the interior of the image forming apparatus to an second orientation that extends outward from a second side of the image forming apparatus and over a portion of the input tray that extends outward from the second side.

15. The method of claim 14, wherein the step of moving the cover from the initial orientation to the second orientation further comprises stretching a biasing mechanism that biases the protective device towards the initial position.

16. The method of claim 14, further comprising positioning a side of the cover at a location within the interior of the image forming apparatus to be contacted by the input tray.

17. The method of claim 14, further comprising extending the cover over a complete top section of the input tray.

18. The method of claim 14, further comprising sliding the cover along a mount when moving the cover from the initial orientation to the second orientation.

19. The method of claim 14, further comprising moving the cover from the second orientation back to the initial orientation during removal of the input tray from the image forming apparatus.

20. The method of claim 14, further comprising positioning a side of the cover against a leading edge of the input tray when moving the cover from the initial orientation to the second orientation.
